(19) United States
(12) Patent Application Publication
(10) Pub. No.: US 2020/0113152 A1
(43) Pub. Date: Apr. 16, 2020

(54) Pet Treat Holder with Adjustable Opening for Gripping Chew Treats or Releasing Kibble Treats

(71) Applicants: Curtis Colatruglio, Winnipeg (CA); Blaine J. Mcfarlane, Winnipeg (CA); Timothy C. Knight, Winnipeg (CA)

(72) Inventors: Blaine J. Mcfarlane, Winnipeg (CA); Timothy C. Knight, Winnipeg (CA)

(21) Appl. No.: 16/601,808

(22) Filed: Oct. 15, 2019

Related U.S. Application Data
(60) Provisional application No. 62/745,781, filed on Oct. 15, 2018.

(51) Int. Cl. A01K 5/01; A01K 15/02

(52) U.S. Cl. CPC A01K 5/0114; A01K 15/026

(57) ABSTRACT

A pet treat holder includes an outer body shell, treat and actuator openings penetrating therethrough, and an adjustment unit having an internal body situated within the shell, and an actuator joined to the internal body for rotation thereof from outside the shell. The internal body has a non-uniform profile, different areas of which are selectively movable into registration with the treat opening by rotation of the actuator to adjust the effective size of an open passageway through said treat opening. In one mode of use, kibble treats are placed inside the hollow interior space the size of the passageway is adjusted to control an ease by which said kibble treats escape through the passageway. In another mode of use, a chew treat is partially inserted through the treat opening, and wedged into a gripped position between the edge of the treat opening and the adjustment unit by rotation thereof.

### CROSS-REFERENCE TO RELATED APPLICATIONS

This application claims benefit under 35 U.S.C. 119(e) of U.S. Provisional Application No. 62/745,781, filed Oct. 15, 2018, the entirety of which is incorporated herein by reference.

### FIELD OF THE INVENTION

The present invention relates generally to pet toys or accessories, and more particularly to pet treat holders for securely holding chew treats or gradually releasing kibble treats.

### BACKGROUND

Recently, devices have been proposed for the purpose of holding chewable pet treats, as shown in U.S. Patent Application US20150313184 and US20170055498. These prior devices employ collet-like clamping mechanisms in which pliable jaws or fingers are tightened around the periphery of a chew toy through relative rotation of an internally threaded collar or ring onto an externally threaded base of the jaws or fingers. Made at least partially of compressible rubber and comprising externally ball-shaped elements of notably greater diameter than the chew treat, these holders provide a pet with improved ability to grasp and hold onto the chew toy, and reduce potential choking hazards.

Additionally, there are a number of ball-shaped kibble treat holders that are commercially available and incorporate some kind of adjustably sized opening through which kibbles are gradually released as the pet plays with the device.

However, there remains room for improvements and alternatives in both of these types of treat holders, and Applicant has developed a unique treat holder design that can be readily used for either secured retention of chew treats, or play-based release of kibble treats.

### SUMMARY OF THE INVENTION

According to a first aspect of the invention, there is provided a pet treat holder comprising:

an outer body comprising a shell delimiting a hollow interior space of said outer body;

a treat opening penetrating through the shell of the outer body;

an actuator opening penetrating through the shell of the outer body;

an adjustment unit comprising:
an internal body residing within the hollow interior of the outer body;
an actuator joined to the internal body and residing at least partially outside the shell of the outer body to enable rotation of the internal body inside outer body via rotation of said actuator;

wherein the internal body of the adjustment unit has a non-uniform profile, different areas of which are selectively movable into registration with the treat opening by rotation of the actuator to adjust an effective size of an open passageway through said treat opening into the interior space of the outer body.

According to a second aspect of the invention, there is provided a pet treat holder comprising:

an outer body comprising a shell delimiting a hollow interior space of said outer body, said outer shell having an exterior surface facing outwardly from said interior space and an opposing interior surface having a concave curvature and facing into said interior space;

an actuator opening that penetrates through the shell of the outer body into the interior space thereof on a first reference axis;

a treat opening penetrating through the shell of the outer body into the interior space thereof on a different side of said shell than the actuator opening, and on a second reference axis of non-parallel relation to the first reference axis;

an adjustment unit comprising:
an internal body residing within the hollow interior of the outer body, said internal body having an outer surface of convex curvature that conforms with the concave curvature of the interior surface of the shell; and
an actuator joined to the internal body and residing at least partially outside the shell of the outer body, said actuator being rotatable about the first reference axis to drive rotation of said internal body;

wherein the internal body of the adjustment unit has a non-uniform profile of varying axial height along said first reference axis in a circumferential direction around said first reference axis, whereby rotation of the adjustment unit moves differently profiled areas of the internal body into registration with the treat opening, thereby adjusting an effective size of a passageway through said treat opening into the interior space of the outer body.

According to a third aspect of the invention, there is provided a pet treat holder comprising:

an outer body comprising a shell delimiting a hollow interior space of said outer body;

a treat opening penetrating through the shell of the outer body into said hollow interior space from an external environment outside said pet treat holder;

an adjustment unit comprising:
a movable body assembled with said outer body and movable into different positions of varying obstruction to said treat opening to thereby adjust an effective size of an open passageway through said treat opening;

wherein the movable body comprises a concave section movable into obstructing relation to said treat opening from one side thereof toward a concave peripheral edge of said treat opening at another side thereof to enable gripping of a chew treat between said concave section of the movable body and said concave peripheral edge of the treat opening by closure of the movable body across said treat opening with said chew treat partially inserted into the outer body through said treat opening.

In one mode of use, any of the forgoing pet treat holders is used in combination with a chew treat, said chew treat being retained in a position having a proximal end disposed inside the hollow interior space of the outer body, an opposing distal end situated outside the outer body, and an intermediate portion transitioning through the passageway in gripped relation between a peripheral edge of the treat opening and part of the adjustment unit.

In another mode of use, any of the forgoing pet treat holders is used in combination with kibble treats, said kibble treats being disposed within the hollow interior of the outer body and the passageway being adjustable in size relative to a kibble size of said kibble treats through use of the adjustment unit to control an ease by which said kibble treats can exit the pet treat holder via said passageway.

According to a fourth aspect of the invention, there is provided a method of using any of the forgoing pet treat holders, said method comprising inserting a proximal end of a chew toy into the hollow interior space of the outer body through the passageway at the treat opening, and, using the adjustment unit, reducing the size of the passageway to thereby wedge the chew toy into a gripped position between a peripheral edge of the treat opening and part of the adjustment unit.

According to a fifth aspect of the invention, there is provided a method of using any of the forgoing pet treat holders, said method comprising placing kibble treats inside the hollow interior space of the outer body, and, using the adjustment unit, adjusting the size of the passageway relative to a kibble size of the kibble treats to thereby control an ease by which said kibble treats can exit the pet treat holder via said passageway.

According to a sixth aspect of the invention, there is provided a method of using a pet treat holder comprising an outer body delimiting a hollow interior space, a treat opening penetrating a shell of the outer body into said hollow interior space and an adjustment unit comprising a movable body assembled with said outer body and movable into different positions of varying obstruction to said treat opening to thereby adjust an effective size of an open passageway through said treat opening, said method comprising inserting a proximal end of a chew toy into the hollow interior space of the outer body through the passageway at the treat opening, and using the adjustment unit, reducing the size of the passageway to thereby wedge the chew toy into a gripped position between a peripheral edge of the treat opening and part of the adjustment unit.

### BRIEF DESCRIPTION OF THE DRAWINGS

One embodiment of the invention will now be described in conjunction with the accompanying drawings in which:

FIG. 1 is an axially exploded elevation view of a pet treat holder according to the present invention.

FIG. 2 is an assembled perspective view of the pet treat holder during preparation thereof to hold a chew treat.

FIG. 3 is an assembled elevation view of the pet treat holder in a partially closed state in which a treat opening of the holder is partially obstructed to reduce the effective size of a passageway between an interior of the holder and a surrounding exterior environment.

FIG. 4 is another assembled elevation view of the pet treat holder in another partially closed state with more of the treat opening obstructed to further reduce the effective size of the passageway.

FIG. 5 is another assembled elevation view of the pet treat holder in a fully closed state in which the treat opening is entirely obstructed to fully close the passageway.

FIG. 6 is a cross-sectional view of the pet treat holder of FIG. 4 as viewed along line A-A thereof.

FIG. 7 is another axially exploded elevation view of the pet treat holder of FIG. 1, with an adjustment unit thereof rotated into a position corresponding to the fully closed state of the pet treat holder.

### DETAILED DESCRIPTION

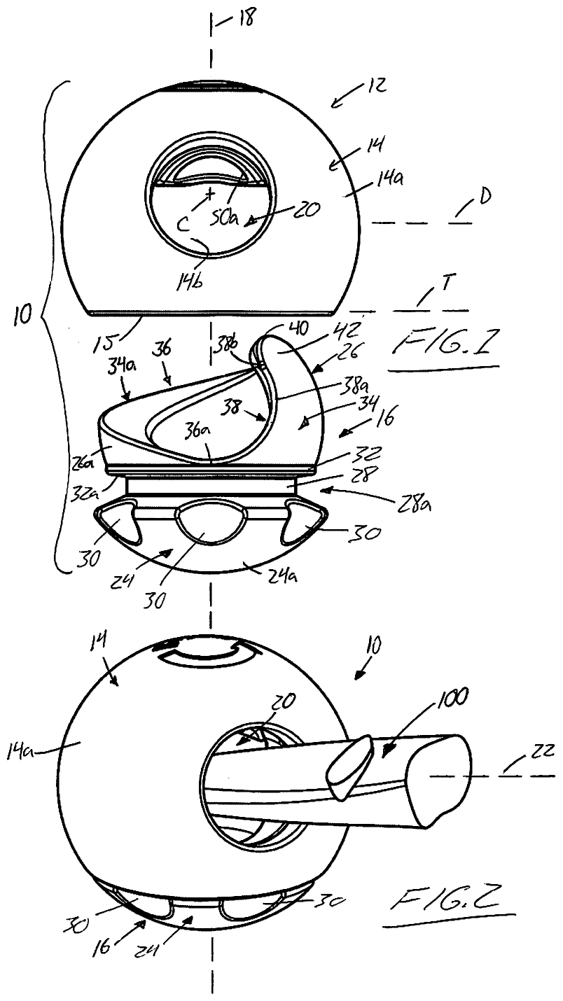

FIG. 1 shows an exploded view of a pet treat holder 10 according to one preferred embodiment of the present invention. The treat holder 10 features an outer body 12 having a shell 14 of dome-like frustospherical shape that spans more than a hemisphere, but less than a full sphere. The shell 14 delimits a hollow interior space of the outer body, and has an open end 15 at the truncation plane T of its frustospherical shape. This open end 15 defines an actuator opening of the outer body that penetrates the shell, and through which an adjustment unit 16 is partially inserted into the hollow interior of the shell 14 during assembly of the treat holder 10. A first reference axis 18 runs fully and centrally through the outer body, and through the installed adjustment unit 16 when assembled therewith. This first reference axis 18 perpendicularly intersects the truncation plane T of the shell's frustospherical shape at the center of the actuator opening, and defines an “axial direction” of the treat holder. At a peripheral side of the shell 14 that is distinct from the open end 15 thereof and lies in non-opposing relation to said open end 15, a treat opening 20 penetrates the shell on a second reference axis 22 that intersects the first reference axis. Due to their intersecting relationship, the first and second reference axes 22 are thus non-parallel to one another.

With reference to FIG. 1, the center C of the circular treat opening 20 in the illustrated embodiment is offset slightly from a diametral plane D of the shell 14 in which a diameter measurement of the shell taken parallel to the shell's truncation plane T is at its maximum. More specifically, the center C of the treat opening 20 is offset to the side of the diametral plane D opposite the truncation plane T at the open end 15 of the shell. Accordingly, in the illustrated embodiment, the second reference axis 22 passing through the center C of the treat opening intersects the first reference plane 18 at a slightly oblique angle thereto, as the second reference axis 22 slopes toward the open end 15 of the shell in its travel into the interior space of the shell. However, it will be appreciated that in other embodiments, the treat opening may be centered on the diametral plane D, in which case the first and second reference axes 18, 22 would lie perpendicular to one another.

The purpose of the adjustment unit 16 is to enable adjustment of the size of an effective passageway through the treat opening 20 between the interior and exterior of the shell 14 of the outer body. The adjustment unit 16 features an actuator 24 that resides primarily outside the shell 14 of the outer body 12 at the open end 15 thereof, an internal body 26 for selectively obstructing the treat opening 20 from inside in the shell 14 of the outer body 12, and a connection portion 28 that joins the actuator 24 and the internal body 26 together so that rotation of the actuator at its accessible location outside the shell 14 drives rotation of the internal body 26 inside the shell 14.

The actuator 24 in the illustrated embodiment is in the form of a scalloped actuator knob having a series of finger notches 30 disposed therein at circumferentially spaced positions around the first reference axis 18. These scalloped finger notches 30 are situated adjacent a wider end of the knob that resides adjacent the open end 15 of the outer body's shell 14 in the assembled state of the treat holder 10. These finger notches 30 enable optimal gripping of the knob between the user's fingers for manual rotation of the adjustment unit 16 around the first reference axis. Aside from these notches 30, the actuator knob of the illustrated embodiment is otherwise dome-shaped, with a spherically contoured exterior surface 24a whose radius of curvature matches the spherically contoured exterior surface 14a of the outer body's shell 14. As shown in the assembled views, the exterior surfaces 14a, 24a of the shell 14 and the actuator knob 24 are thus of matching spherical contour and flush alignment with one another in the assembled state of the treat holder, thereby providing the overall treat holder with a spherically ball-shaped exterior. In other words, the domed shape of the actuator knob 24, with its apex situated on the first reference axis 18, compliments the frustospherical shape of the outer body to give the overall treat holder a fully spherical ball shape.

Referring again to FIG. 1, the connecting portion 28 of the adjustment unit 16 is a reduced-diameter neck of lesser diameter than the actuator knob 24 and the internal body 26. A base 32 of the internal body 26 thus forms an overhanging shoulder 32a at the end of the reduced-diameter neck opposite the actuator knob 24. A profiled circumferential wall 34 of the internal body 26 projects axially from the base 32 thereof on the side thereof opposite the reduced-diameter neck 28, and spans a full circumference of the base 32 around the first reference axis 18. The circumferential wall 34 has a non-uniform profile of varying axial height at different locations around the reference axis 18.

A ramped section 36 of the circumferential wall's non-uniform profile has a starting end 36a at which the axial height of the circumferential wall is at a minimum, e.g. flush with or closely adjacent the base 32 whose underside defines the overhanging shoulder 32a. From this starting end 36a, the axial height of the ramped section 36 increases at a constant slope on a helical path in a first circumferential direction around the first reference axis 18. The constant slope of the ramped section 36 ceases at a terminal end 36b thereof, where the circumferential wall 34 is of notably greater axial height. In this context, axial height is measured in the axial direction of first reference axis 18 from a suitable reference plane lying normal thereto at or near the actuator opening to a terminal edge of the circumferential wall furthest from the base 32. In the illustrated example, truncation plane T at the open end of the outer body's shell is used as this reference plane.

The non-uniform profile of the circumferential wall 34 also features a concavely back-turned section 38, where the terminal edge 34a of the circumferential wall continues from the starting end 36a of the ramped section 36 in a second circumferential direction opposite the ramped section's direction of increasing axial height. At this concavely back-turned section 38, the terminal edge 34a of the circumferential wall initially slopes away from the base 32 in this second circumferential direction, but on a concave path of increasing slope, until the slope of the free edge 34a reaches an orientation parallel to the first reference axis 18 at an intermediate point 38a of the concavely back-turned section 38. From here, the free edge 34a continues its concave curvature, and thus tilts back in the first circumferential direction up to an end point 38b of the concavely back-turned section. A convex transition section 40 then continuously extends from this end point 38b of the concave back-turned section 38, and curves back in the second circumferential direction to join up with the terminal end 36b of the ramped section.

In summary, the terminal edge 34a of the circumferential wall 34 of the internal body 26 has a ramped section 36 of constant slope, a convexly curved transition section 40 joined with an axially tallest terminal end 38b of the ramped section 36, and a concavely back-turned section 38 joining the convexly curved transition section 40 to the axially shortest starting end 36a of the ramped section 36. A tallest area 42 of the circumferential wall 34 is that which reaches furthest from the base 32 of the internal body 26 and is bound between the base 32 and the convexly curved transition section 40 of the wall's terminal edge 34a.

The outer body 12 and the adjustment unit 16 are made of molded rubber or other resilient material with sufficient thickness in the shell 14 of the outer body to withstand repeated biting by a dog or other pet, but with sufficient pliability in the base 32 and circumferential wall 34 of the internal body 26 to enable temporary inward collapse thereof from its normal default shape to a size passable through the actuator opening at the open end 15 of the outer body's shell 14 during assembly of the treat holder. Subsequent to such insertion, the internal body 26 will resiliently expand back to its default shape inside the shell 14 of the outer body 12. In this normal default shape of the internal body 26, a convexly spherical outer surface 26a of the internal body's circumferential wall 34 fits in conforming contact or proximity with a concavely spherical interior surface 14b of the outer body's shell. The matching spherical curvature of these surfaces allows them to slide relatively over one another when the adjustment unit is rotated about the first reference axis 18.

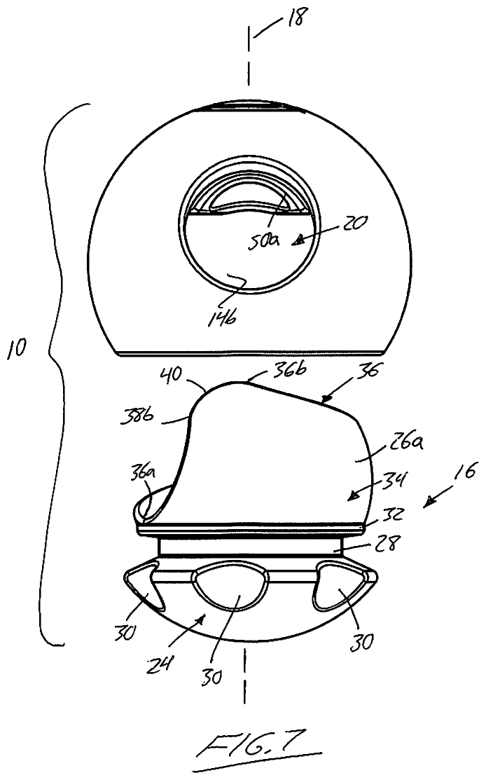

As shown in the cross-sectional view of FIG. 6, the open end 15 of the outer body's shell 14 features an in-turned flange 15a that projects inwardly from the shell's spherically contoured interior surface 14b and delimits the actuator opening of the outer body. This flange 15a hooks around the overhanging shoulder 32a of the adjustment unit 16 and reaches into the annular groove 28a that exists around the reduced neck 28 of the adjustment unit 16 between the adjustment knob 24 and the base 32 of the internal body 26. The flange 15a of the outer body thus serves to block withdrawal of the internal body 26 from the outer body once the two are assembled, while the reduced neck 28 of the adjustment unit reaches through the actuator opening in order to connect the externally located actuator knob 24 to the internal body 26.

With the outer body and the adjustment unit assembled so as to dispose the internal body 26 inside the shell 14 of the outer body 12, rotation of the actuator knob 24 around the first reference axis 18 thus drives rotational movement of the internal body 26 about the same axis 18. As different areas of the profiled circumferential wall 34 of the internal body 26 move past the treat opening 20 in the shell of the outer body, different areas of the overall treat opening 20 will be obstructed, thereby adjusting the effective size of the available passageway through the treat opening 20 between the hollow interior of the outer body and the surrounding exterior environment.

In the assembled state of the treat holder, the minimum axial height of the circumferential wall 34 of the internal body 26 at the starting end 36a of the ramp section 36 is less than the axial distance from the reference truncation plane T to the nearest side of the treat opening 20. Accordingly, when the adjustment unit 16 is rotated into an open position placing the starting end 36a of the ramp section 36 in alignment with the center of the treat opening 20 in the circumferential direction around the first reference axis, this shortest part of the circumferential wall 34 at the starting end of the ramp section 36 terminates short of the treat opening 20. In this open position of the adjustment unit, the treat opening 20 is thus entirely unobstructed, thereby maximizing the size of the passageway through the treat opening. The exploded view of FIG. 1 shows the adjustment unit 16 in its open position around the first reference axis 18.

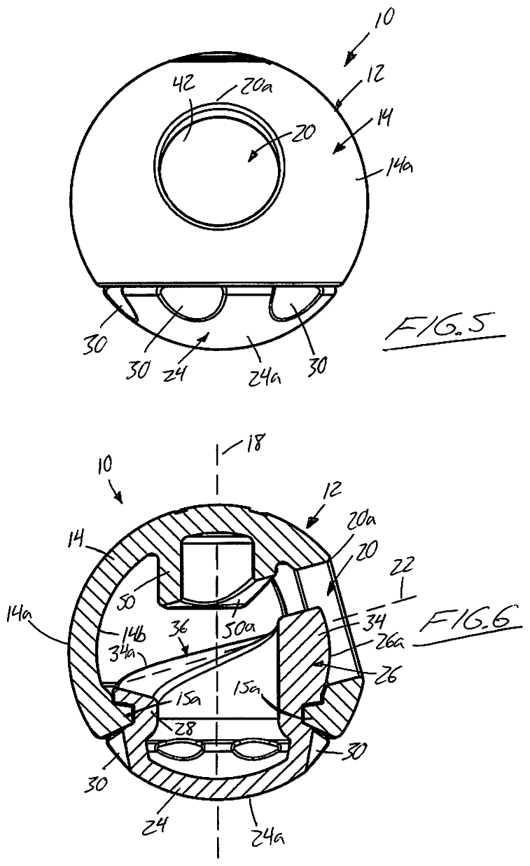

On the other hand, the maximum axial height of the circumferential wall 34 of the internal body 26 at the tallest area 42 thereof underlying the convex transition section 40 of the wall's terminal edge is greater than the axial distance from the reference truncation plane T to the furthest side of the treat opening 20. Accordingly, when the adjustment unit 16 is rotated into a closed position placing the convex transition area 40 in alignment with the treat opening around the first reference axis 18, the tallest area 42 of the circumferential wall of the internal body 26 reaches fully across the treat opening 20. The exploded view of FIG. 7 shows the adjustment unit its closed position around the first reference axis 18. In this closed position of the adjustment unit, the treat opening 20 is thus entirety obstructed as shown in FIG. 5, thereby minimizing the size of the passageway down to zero. By comparison, FIG. 3 shows the passageway in a partially closed state where a first area of the ramp section 36 of the internal body has been rotated into registration with the treat opening 20, while FIG. 4 shows the passageway in another partially closed state where a greater fraction of the treat opening 20 has been obstructed by rotation of a taller second area of the ramp section 36 into registration with the treat opening 20.

In one mode of use, also referred to herein as the kibble mode of use, the first end 36a of the ramp section 36 of the internal body 26 is rotated into alignment with the treat opening's position around the first reference axis 18, thereby maximizing the passageway size to enable easy insertion of kibble treats into the hollow interior space of the outer body through the fully opened treat opening 20. The size of the passageway can then be adjusted to control the ease with which individual kibbles will be released from the treat holder under rolling movement or forceful impact thereof by a pet. The passageway may be adjusted to a relatively small size only slightly exceeding the kibble size of the kibble treats in order to decrease the ease and rate of kibble release, or adjusted to a larger size that more greatly exceeds the kibble size in order to increase the ease and rate of kibble release.

As mentioned above, FIG. 5 shows the passageway in the fully closed state in which the convex transition section 40 of the terminal edge of the internal body's circumferential wall has been rotated into registration with a distal corner of the treat opening so that the tallest area 42 of the circumferential wall underlying the convex transition section blocks off the entirety of the treat opening to fully close off the passageway. This may be useful, for example, to store kibble treats inside the treat holder between uses thereof in the kibble mode.

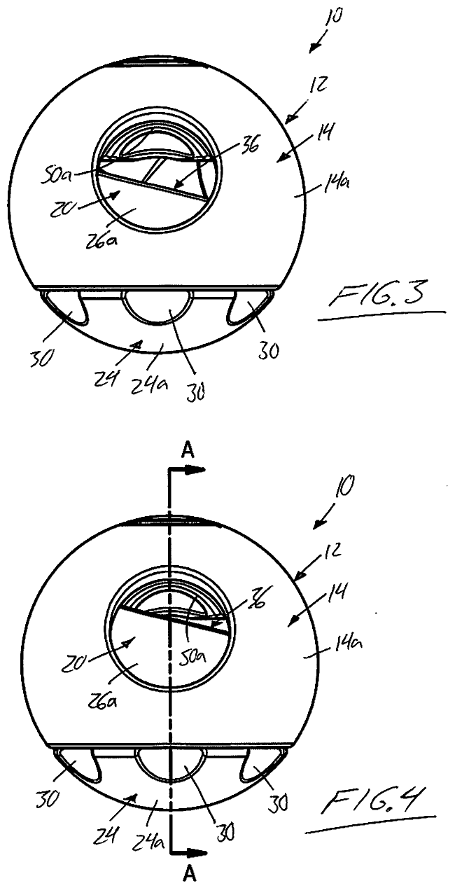

FIG. 2 shows another mode of use, also referred to herein as a “chew mode” of use, where rather than using the adjustably sized passageway to gradually release kibble treats during rolling and other movement of the treat holder, the adjustably sized passageway is instead used to capture and support a chew treat 100 (e.g. antler, bone, bully stick, rawhide stick, etc.) in a position partly received in the treat holder, and partly projecting outward therefrom. In this mode of use, the treat holder forms a grip aid on one end of the chew treat by which a pet can better grip and manipulate the chew treat, and also forms a bulbous enlargement on the end of the chew treat that prevents swallowing of the chew treat as a potential choke hazard.

With the passageway at or near its fully opened state, a proximal end of the chew treat 100 is inserted through the passageway into the interior space of the outer body 12. An intermediate portion of the chew treat projects outwardly through the treat opening and carries the opposing distal end of the chew treat in the exterior environment outside the treat holder. Instead of rotating the adjustment unit 16 in the direction moving the taller area 42 of the internal body 26 toward the treat opening 20, the adjustment unit 16 is instead rotated in the opposite direction drawing the concave back-turned section 38 of the internal body into registration with the treat opening 20. This drives the concavely contoured section 38 of the internal member's circumferential wall 34 against a respective side of the chew treat 100 at the intermediate portion thereof disposed inside the treat opening 20. This forces the opposing side of the chew treat 100 against the concave peripheral edge of the treat opening 20 at the side thereof opposite that from which the concave section 38 of the internal member is moving across the treat opening. Through cooperation of the concave peripheral edge of the round treat opening 20 in the outer body and the concavely backed-turned edge section 38 of the internal body, a good conforming fit is achieved on both sides of the chew treat for optimal gripping thereof. This gripping action is further improved by the rubber or other resilient composition of the outer body's shell and the internal body of the adjustment unit.

The closely conforming fit between the convex outer surface of the resilient-material internal body and the convex interior surface of the shell of the resilient-material outer body, and/or between the in-turned flange 15a of the resilient-material outer body and the reduced connecting portion 28 of the resilient-material adjustment unit, provide notable frictional resistance to relative rotation between the two bodies, whereby the snugly gripped condition of the chew treat between the two bodies is not inadvertently released during play by the animal, and is only loosened upon intentional manual gripping and rotation of the actuator 24.

As best shown in the cross-section of FIG. 6, an internal boss 50 of the outer body protrudes inwardly from the concave interior surface 14b of the shell 14 at a location thereon situated opposite the actuator opening. At a distal end 50a of the boss furthest from its connection to the shell's internal surface 14b, the internal boss 50 is obliquely truncated at a concave plane whose radius of curvature is centered on the second reference axis 22 and is equal to the radial measure of the treat opening 20. Accordingly, the peripheral edge of the treat opening 20 and the distal end 50a of the boss 50 both reside in a shared cylindrical plane centered on the second reference axis 22. As a result, the far side of the treat opening 20 situated furthest from the actuator opening is aligned with the distal end 50a of the boss 50 in the direction denoted by the second reference axis 22. When the proximal end of a chew treat 100 is inserted into the hollow interior of the shell through the treat opening, the boss 50 blocks or limits deflection of the chew treat's proximal end away from the actuator opening toward the opposing closed-dome end of the outer body's shell 14. This helps stabilize the chew treat in a secured position when gripped between the circumferential wall 34 of the internal body 26 and the peripheral edge of the treat opening 20 in the outer body's shell 14.

While the illustrated embodiment of the pet treat holder is spherically ball-shaped to enable rolling movement thereof in any direction when used in the kibble mode, the external shape of the pet holder may vary. In one alternate example, the pet treat holder may be externally cylindrical to still enable smooth back and forth rolling on the cylindrical outer circumference of the outer body in the kibble mode. In other examples, the exterior of the pet treat holder may be flat-sided or block shaped, lending to a rough tumbling motion in the kibble mode rather than a smooth rolling motion. Likewise, the concave and convex curvatures at the interior surface of the outer body and the outer surface of the inner body to allow relative rotation between the inner and outer bodies need not necessarily be spherically contoured, as cooperating cylindrical surfaces would also be capable of allowing relative rotation between the outer and inner bodies about the first reference axis to move the different areas of the inner body's variably profiled circumferential wall into registration with the treat opening.

Since various modifications can be made in my invention as herein above described, and many apparently widely different embodiments of same made, it is intended that all matter contained in the accompanying specification shall be interpreted as illustrative only and not in a limiting sense.

1. A pet treat holder comprising:
an outer body comprising a shell delimiting a hollow interior space of said outer body;
a treat opening penetrating through the shell of the outer body;
an actuator opening penetrating through the shell of the outer body;
an adjustment unit comprising:
an internal body residing within the hollow interior of the outer body;
an actuator joined to the internal body and residing at least partially outside the shell of the outer body to enable rotation of the internal body inside outer body via rotation of said actuator;
wherein the internal body of the adjustment unit has a non-uniform profile, different areas of which are selectively movable into registration with the treat opening by rotation of the actuator to adjust an effective size of an open passageway through said treat opening into the interior space of the outer body.

2. The pet treat holder of claim 1 wherein the shell of the outer body has a concave interior surface facing into said interior space, and the internal body of the adjustment unit has a convex outer surface that conforms with the concave interior surface of the shell.

3. The pet treat holder of claim 2 wherein the concave interior surface of the shell of the outer body and the convex outer surface of the internal body are spherically contoured.

4. The pet treat holder of claim 1 wherein the treat opening is situated on a different side of said shell than the actuator opening.

5. The pet treat holder of claim 1 wherein the treat opening and the actuator opening penetrate the shell of the outer body on non-parallel axes.

6. The pet treat holder of claim 2 wherein:
the actuator opening penetrates through the shell of the outer body into the interior space thereof on a first reference axis;
the treat opening penetrates through the shell of the outer body into the interior space thereof on a different side of said shell than the actuator opening, and on a second reference axis of non-parallel relation to the first reference axis; and
wherein the non-uniform profile of the internal body of the adjustment unit has a varying axial height along said first reference axis in a circumferential direction around said first reference axis, whereby rotation of the adjustment unit moves differently profiled areas of the internal body into registration with the treat opening, thereby adjusting the effective size of the passageway through said treat opening into the interior space of the outer body.

7. The pet treat holder of claim 1 wherein the non-uniform profile of the internal body of the adjustment unit comprises a ramped section of increasing axial height from a starting end of said ramped section to an opposing terminal end thereof in a first circumferential direction around said internal body, whereby rotation of the internal body from a position placing the starting end of the ramped section in alignment with the treat opening to a position placing the terminal end of the ramped section in alignment with the treat opening gradually reduces the size of the passageway by gradually obstructing more of the treat opening with the ramped section of the internal body.

8. The pet treat holder of claim 7 wherein the non-uniform profile of the internal body of the adjustment unit, moving away from the starting end of the ramped section in a second circumferential direction, transitions into a concavely back-turned section that initially increases in axial height in said second circumferential direction and then curves back over itself in the first circumferential direction.

9. The pet treat holder of claim 1 wherein the non-uniform profile of the internal body of the adjustment unit comprises a concavely back-turned sectioned that initially increases in axial height in one circumferential direction around the internal body and curves back over itself in an opposing circumferential direction around the internal body.

10. The pet treat holder of claim 1 wherein a minimum axial height of the internal body occurring at an axially shortest point thereof, and measured from a reference plane at the actuator opening, is less than an axial distance from said reference plane to a nearest side of the treat opening, whereby rotation of the adjustment unit into a position aligning said axially shortest point on the internal body with the treat opening in the shell of the outer body leaves an entirety of the treat opening unobstructed to maximize the size of the passageway.

11. The pet treat holder of claim 10 wherein a maximum axial height of the internal body occurring at an axially tallest point thereof, and measured from the reference plane at the actuator opening, is greater than an axial distance from said reference plane to a furthest side of the treat opening, whereby rotation of the adjustment unit into a position aligning the axially tallest point of the internal body with the treat opening in the shell of the outer body entirely obstructs the treat opening to fully close the passageway.

12. The pet treat holder of claim 1 wherein the external actuator comprises an actuation knob having a series of finger notches therein at circumferentially spaced positions therearound.

13. The pet treat holder of claim 1 wherein the external actuator comprises an exterior surface in flush alignment with an exterior of the outer body.

14. The pet treat holder of claim 1 wherein the outer body and the external actuator share a matching spherical exterior contour.

15. A pet treat holder comprising:
an outer body comprising a shell delimiting a hollow interior space of said outer body;
a treat opening penetrating through the shell of the outer body into said hollow interior space from an external environment outside said pet treat holder;
an adjustment unit comprising:
a movable body assembled with said outer body and movable into different positions of varying obstruction to said treat opening to thereby adjust an effective size of an open passageway through said treat opening;
wherein the movable body comprises a concave section movable into obstructing relation to said treat opening from one side thereof toward a concave peripheral edge of said treat opening at another side thereof to enable gripping of a chew treat between said concave section of the movable body and said concave peripheral edge of the treat opening by closure of the movable body across said treat opening with said chew treat partially inserted into the outer body through said treat opening.

16. The pet treat holder of claim 15 wherein said concave section and said concave peripheral edge each feature resilient material.

17. The pet treat holder of claim 1 in combination with kibble treats, said kibble treats being disposed within the hollow interior of the outer body and the passageway being adjustable in size relative to a kibble size of said kibble treats through use of the adjustment unit to control an ease by which said kibble treats can exit the pet treat holder via said passageway.

18. A method of using the pet treat holder of claim 1, said method comprising placing kibble treats inside the hollow interior space of the outer body, and, using the adjustment unit, adjusting the size of the passageway relative to a kibble size of the kibble treats to thereby control an ease by which said kibble treats can exit the pet treat holder via said passageway.

19. In combination with a chew treat, a pet treat holder comprising:
an outer body comprising a shell delimiting a hollow interior space of said outer body;
a treat opening penetrating through the shell of the outer body into said hollow interior space from an external environment outside said pet treat holder; and
an adjustment unit comprising a movable body assembled with said outer body and movable into different positions of varying obstruction to said treat opening to thereby adjust an effective size of an open passageway through said treat opening;
wherein said chew treat is retained in a position having a proximal end disposed inside the hollow interior space of the outer body, an opposing distal end situated outside the outer body, and an intermediate portion transitioning through the passageway in gripped relation between a peripheral edge of the treat opening and part of the adjustment unit.

20. A method of using the combination of claim 19 comprising inserting the proximal end of the chew toy into the hollow interior space of the outer body through the passageway at the treat opening, and using the adjustment unit, reducing the size of the passageway to thereby wedge the chew toy into a gripped position between the peripheral edge of the treat opening and said part of the adjustment unit.
